(19) United States
(12) Patent Application Publication
(10) Pub. No.: US 2018/0216054 A1
(43) Pub. Date: Aug. 2, 2018

(54) METHOD FOR PURIFYING DISTILLED SPIRITS

(71) Applicant: Sidereal Pty Ltd., Chapman (AU)

(72) Inventor: Tobias Angstmann, Chapman (AU)

(21) Appl. No.: 15/881,310

(22) Filed: Jan. 26, 2018

Related U.S. Application Data
(60) Provisional application No. 62/451,785, filed on Jan. 30, 2017.

(51) Int. Cl. C12H 1/07; C12H 1/044; B01D 9/00

(52) U.S. Cl. CPC C12H 1/063; B01D 2009/0086; B01D 9/00; C12H 1/0408

(57) ABSTRACT

A method for purifying distilled spirits includes cooling a distilled spirit to a temperature at which contaminants in the selected distilled spirit crystallize. The cooled, selected distilled spirit is passed through a first hollow fiber permeable membrane having openings smaller than a size of the crystallized contaminants.

### CROSS REFERENCE TO RELATED APPLICATIONS

Priority is claimed from U.S. Provisional Application No. 62/451,785 filed on Jan. 30, 2017 and incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of manufacture of potable distilled spirits. More specifically, the disclosure relates to processes for purification of distilled spirits so as to improve taste characteristics of a final product.

Vodka is the largest internationally traded spirit sold and consumed in the world at present. Vodka is a non-aged neutral spirit that can be distilled from potatoes, rye, wheat, barley, corn, and many other fermentable materials.

The majority of vodka sold and consumed today, however, is not distilled by the bottler. 95% alcohol by volume (ABV) grain neutral spirits (GNS) or neutral cane spirits (NCS) may be made by continuous ethanol distillation plants. Manufacturers simply add water and/or flavoring to the GNS or NCS before bottling and selling the resulting product as vodka.

Vodka made according to such known processes, however, have significant amounts of undesirable alcohols and other products that are known to impart undesirable flavors and odors to the vodka. These same constituents may contribute to hangovers. As a result, those vodkas are low quality with poor taste and odor. A table of these common contaminants is shown below as Table 1.

TABLE 1
COMMON CONTAMINANTS IN COMMERCIAL VODKA

| | Chemical | Boiling | Molar mass | Density | Melting |
|---|---|---|---|---|---|
| Substance | formula | point (° C.) | (g/mol) | (kg/m³) | point (° C.) |
| acetaldehyde | C₂H₄O | 20.2 | 44.05 | 788 | −123.5 |
| propionaldehyde | C₃H₆O | 48.8 | 58.08 | 810 | −81 |
| methyl acetate | C₃H₆O₂ | 56.9 | 74.08 | 932 | −98 |
| methanol | CH₄O | 64.7 | 32.04 | 792 | −97.6 |
| butyraldehyde | C₄H₈O | 74.8 | 72.11 | 802 | −96 |
| ethyl acetate | C₄H₈O₂ | 77.1 | 88.11 | 897 | −83.6 |
| methyl propionate | C₄H₈O₂ | 80 | 88.11 | 915 | −88 |
| isopropanol | C₃H₈O | 82.6 | 60.1 | 786 | −89 |
| allyl alcohol | C₃H₆O | 97 | 58.08 | 854 | −129 |
| 1-Propanol | C₃H₈O | 98 | 60.1 | 803 | −126 |
| butanol | C₃H₁₀O | 117.7 | 74.12 | 810 | −89 |
| ethyl propionate | C₅H₁₀O₂ | 98.9 | 102.13 | 844 | −73 |
| propyl acetate | C₅H₁₀O₂ | 102 | 102.13 | 890 | −95 |
| 3 methyl-2-butanol | C₅H₁₂O | 109 | 88.15 | 818 | −50 |
| isobutyl acetate | C₆H₁₂O₂ | 118 | 116.16 | 0.875 | −99 |
| 3-methyl-1-butonal | C₅H₁₂O | 131.1 | 88.15 | 810 | −117 |
| isobutyl propionate | C₇H₁₄O₂ | 137 | 130.19 | 869 | −71.4 |
| isoamyl acetate | C₇H₁₄O₂ | 142 | 130.19 | 867 | −78 |
| butyl propionate | C₇H₁₄O₂ | 146 | 130.19 | 900 | −90 |
| heptanol | C₇H₁₅O | 175 | 116.2 | 819 | −34.6 |
| furfuryl alcohol | C₅H₆O₂ | 170 | 98.1 | 1.128 | −29 |
| methyl heptanoate | C₈H₁₆O | 173 | 144.21 | 900 | −56 |
| phenyl acetate | C₈H₈O₂ | 195 | 136.15 | 1075 | 50 |
| ethyl hexadecanoate | C₁₈H₃₆O₂ | 377 | 284.48 | 857 | 22 |

Spirits matured in wood containers will have much higher concentrations of these and other contaminants such as gallic acid, short and long chain esters (e.g., thyl laureate (ethyl-dodecanoate), ethyl-palmitate (ethyl-hexadecanoate) and ethyl-9-hexadeanoate (ethyl-palmitoleate), high molecular weight lipids and fussed alcohols.

Thus, a need exists for a method for producing high quality spirits that contain low levels of undesirable alcohols and other contaminants.

### SUMMARY

A method for purifying distilled spirits according to one aspect of the present disclosure includes cooling a distilled spirit to a temperature at which contaminants in the carbon filtered, selected distilled spirit crystallize. The cooled, distilled spirit is filtered through a first hollow fiber permeable membrane having openings smaller than a size of the crystallized contaminants.

Some embodiments further comprise filtering a selected distilled spirit through an activated carbon filter prior to cooling.

In some embodiments the temperature is −20 degrees C.

In some embodiments, the cooling is performed at a rate of at most 2 degrees C. per hour.

In some embodiments, filtering through the activated carbon filter is repeated a plurality of times.

In some embodiments, filtering through the activated carbon filter is repeated between zero and nine times.

In some embodiments, the activated carbon filter is in block form.

In some embodiments, a pressure of the selected distilled spirit prior to the filtering in the activated carbon filter is at most 2 pounds per square inch.

In some embodiments, the filtering through the first hollow fiber permeable membrane is performed using compressed gas at a selected pressure to urge the cooled distilled spirit through the first hollow fiber permeable membrane.

In some embodiments, a pressure of the compressed gas is 20 pounds per square inch.

Some embodiments further comprise filtering the cooled, membrane filtered spirit through a second hollow fiber permeable membrane having openings smaller than the openings in the first hollow fiber permeable membrane.

Some embodiments further comprise diluting the selected distilled spirit to a predetermined alcohol concentration with water prior to filtering through the activated carbon filter.

Other aspects and possible advantages will be apparent from the description and claims that follow.

### BRIEF DESCRIPTION OF THE DRAWINGS

FIG. 1 shows a flow chart of an example process for purification of GNS or NCS according to the present disclosure.

### DETAILED DESCRIPTION

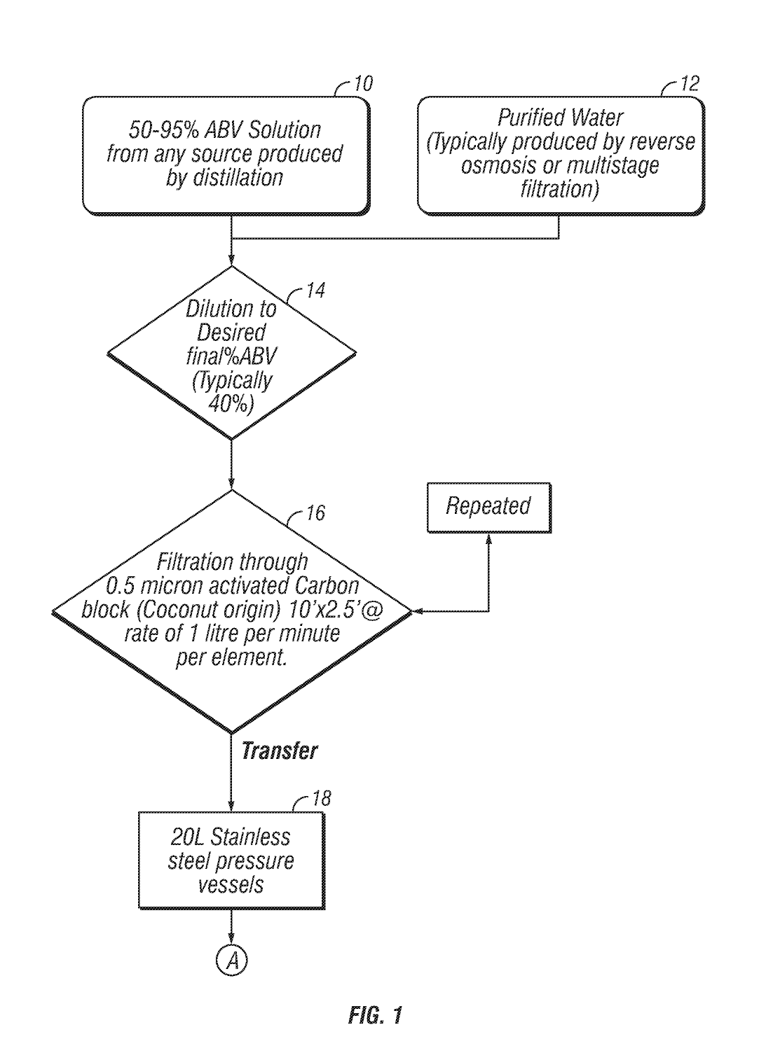

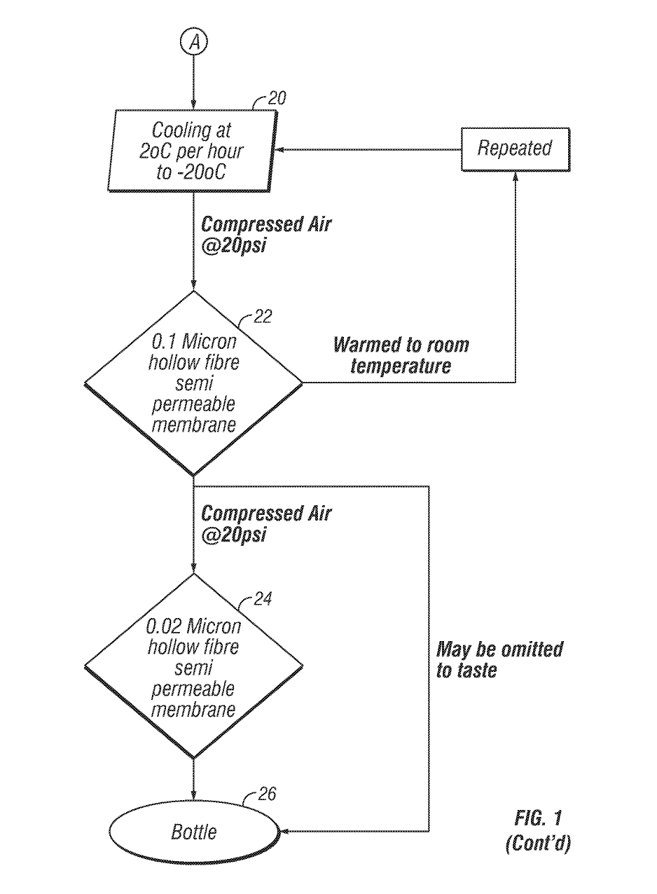

An example method according to the present disclosure may be better understood with reference to FIG. 1. The example process begins with the selection of the base distilled spirit at 10. The base distilled spirit may be distilled through processes known in the art, e.g., fermentation of sugars, then pot or column distillation of ethanol. In some embodiments the base distilled spirit may be acquired industrial neutral spirits.

The base distilled spirit is diluted at 14, using filtered water or other clean water supply at 12, to the desired alcohol content by volume. Multistage reverse osmosis of water may be used for the supply of dilution water 12.

The diluted base distilled spirit may then be filtered, at 16, through one or more passes through one or more activated carbon filters. The activated carbon filter(s) may be block type or granular activated carbon. In the present example embodiment, block type activated carbon may be superior to granulated type filters in order to reduce sediment tailings. The flow rate may be limited to about 0.5 gallons per minute (gpm) for a 10 foot long, 2.5 foot square cross-section block activated carbon filter element. The pressure of the diluted distilled spirit ahead of the activated carbon filter should be at most about 2 pounds per square inch (psi).

Filtration 16 may be repeated, in the present example embodiment, 5 times. A range of number of filtration passes may be 1-10.

The filtered, diluted GNS or NCS may then be transferred, at 18. into one or more selected volume, e.g., 5 gallon (20 liter), stainless steel pressure containers. After filling with filtered, diluted spirit (hereinafter the “liquid”), the pressure containers may be slowly cooled, at 20, (e.g., at 2° C. per hour) to a final temperature of −20° C.

Once the liquid in the pressure container(s) is cooled to the foregoing temperature, the pressure container(s) is/are pressured with filtered compressed air or other compressed at a pressure of, for example, 20 psi to displace the cooled liquid from the pressure container(s). The displaced liquid may then be passed, at 22, through a hollow fiber membrane. The hollow fiber membrane may be made from, for example, cellulose acetate, polysulfone, polyethersulfone, and polyvinylidene fluoride. The lateral pore size of the membrane may be about 0.1 micron. The lateral pore size may be confirmed, for example, by evapoporometry.

A continuous, U shaped arrangement of hollow fibers may be used in the membrane. After passage through the hollow fiber membrane at 22, the liquid may be returned to room temperature, and then cooled again (e.g., at 2° C. per hour) to −20° C.

The cooled, hollow fiber membrane-filtered liquid may be further filtered, at 24, through a 0.02 micron hollow fiber, semi-permeable membrane. The further filtered liquid may then be returned to room temperature, tested for pH and final ABV, and then bottled, at 26.

The foregoing method may take advantage of a number of physical properties. Carbon filtering is an effective method for removal of volatile organic compounds (VOCs) and other contaminants. The slow cooling of the liquid induces crystal formation in contaminants that would in the absence of such crystal formation be too small for interaction with the carbon filter and the hollow fiber membrane. At −20° C. the contaminant crystals are large enough so as not to be able to pass through the 0.1 micron hollow fiber membrane and 0.02 hollow fiber, semi-permeable membrane and the resultant solution is pleasant to taste.

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f), for any limitations of any of the claims herein, except for those in which the claim expressly uses the words “means for” together with an associated function.

What is claimed is:

1. A method for purifying distilled spirits, comprising:
cooling a distilled spirit to a temperature at which contaminants in the distilled spirit crystallize; and
filtering the cooled, distilled spirit through a first hollow fiber permeable membrane having openings smaller than a size of the crystallized contaminants.

2. The method of claim 1 wherein the cooling is performed at a rate of at most 2 degrees C. per hour.

3. The method of claim 1 wherein the temperature is −20 degrees C.

4. The method of claim 1 further comprising filtering the distilled spirit through an activated carbon filter prior to the cooling.

5. The method of claim 4 wherein the filtering through the activated carbon filter is repeated a plurality of times.

6. The method of claim 5 wherein the filtering through the activated carbon filter is repeated between two and nine times.

7. The method of claim 4 wherein the activated carbon filter is in block form.

8. The method of claim 7 wherein a pressure of the selected distilled spirit prior to the filtering in the activated carbon filter is at most 2 pounds per square inch.

9. The method of claim 1 wherein the filtering through the first hollow fiber permeable membrane is performed using compressed gas at a selected pressure to urge the cooled distilled spirit through the first hollow fiber permeable membrane.

10. The method of claim 9 wherein a pressure of the compressed gas is 20 pounds per square inch.

11. The method of claim 1 further comprising filtering the cooled, membrane-filtered spirit through a second hollow fiber permeable membrane having openings smaller than openings in the first hollow fiber permeable membrane.

12. The method of claim 11 wherein the openings in the first hollow fiber membrane have a lateral pore size of 0.1 microns.

13. The method of claim 11 wherein the openings in the second hollow fiber membrane have lateral pore size of 0.02 microns.

14. The method of claim 1 further comprising diluting the selected distilled spirit to a predetermined alcohol concentration with water prior to filtering through the activated carbon filter.
